(19) United States
(12) Patent Application Publication
(10) Pub. No.: US 2003/0130942 A1
(43) Pub. Date: Jul. 10, 2003

(54) Automated invoice receipt and management system with automated loading systems

(75) Inventors: Eric Campbell, Rye, NH (US); Robert F. Hoffman, Auburndale, NY (US); Robert Maloney JR., Massapequa Park, NY (US); Maris N. Lemanis, Smithtown, NY (US)

Correspondence Address: TIMOTHY P. O'HAGAN, 8710 KILKENNY CT, FORT MYERS, FL, 33912, US

(73) Assignee: Bottomline Technologies (DE) Inc., Portsmouth, NH (US)

(21) Appl. No.: 10/139,596

(22) Filed: May 6, 2002

Related U.S. Application Data
(63) Continuation-in-part of application No. 10/041,513, filed on Jan. 8, 2002.

(51) Int. Cl. G06F 17/60

(52) U.S. Cl. 705/40

(57) ABSTRACT

An automated invoice management system includes a network circuit for communicating invoice transactions with a plurality of client systems. The automated invoice management system receives an import invoice transaction compliant with a first client transaction definition from a first client system. The import invoice transaction identifies a second client system using values that are recognized by the first client system. The import invoice transaction is translated to a normalized invoice transaction and the normalized transaction is translated to an export invoice transaction compliant with a second client transaction definition. The first client system is identified in the export invoice transaction using values recognized by the second client system.

### CROSS REFERENCE TO RELATED APPLICATIONS

The present application is a continuation in part of U.S. patent application Ser. No. 10,041,513 entitled Automated Invoice Receipt and Management System with Field Value Substitution filed on Jan. 8, 2002 the contents of such patent application is incorporated herein.

### TECHNICAL FIELD

The present invention relates to a financial transaction system and method, and more particularly, to an improvement for a network-based system and method for automated invoice receipt and management.

### BACKGROUND OF THE INVENTION

Typically a business will have an accounting software system that maintains a database of the business transactions with its customer, vendors, banks, and other third parties associated with the business as well as internal business transactions between internal accounts. The typical architecture of such accounting systems provides for data to be input into the system through predefined transactions. The system then updates applicable records in the data base.

For example, when an invoice is received from a vendor, an accounts payable employee will typically open a manual data entry (MDE) screen or panel which prompts the employee to enter each element of data from the invoice and then submit the entered data to the application as a single transaction. At that time the system will write the newly entered invoice into the database. To assure that all necessary transaction data is complete, the application will not accept the transaction and update the applicable records in the database until all required fields have been entered and the data is validated.

While these accounting system facilitate record keeping and may reduce data entry for internal transactions, transactions between business have traditionally been handled by one businesses software system printing a document and the other business manually entering the transaction into their system using data from the document.

To facilitate the exchange of transaction documents electronically, in 1979 the American National Standards Institute (ANSI) charted the Accredited Standards Committee (ASC) to develop and maintain a standard for Electronic Data Interchange (EDI) of business transaction documents.

The ANSI ASC X12 “standards” are essentially a uniform syntax for packaging ASCII data items that comprise a business transaction. The syntax is simple, applying a lightly-structured set of labels and positional rules, and a looping structure, on ordinary ASCII characters. The key feature of an X12 standard transaction is that it is totally independent of the mechanical means of transmittal of information. The standards are for the interchange of data: information can be coded in X12 on one platform and application program, and transmitted—using floppy diskette, magnetic tape, or by any type of real-time or batch or packet telecommunication, or a combination of these methods—to any other platform and application program having an electronic X12 interpreter. The standards control simply the coding format used, rather than the transmission method.

ANSI ASC X12 syntax rules and code values are organized at four levels of transmission control standards, transaction set standards, segment directory and positional rules, and data element dictionary.

The transmission (or interchange) control standards provide for the overall electronic envelope in which one or more X12 transaction sets are carried from sender to receiver(s). The transmission control standards define such items as: how transaction sets are identified and how beginnings and endings of the transaction sets are defined, grouping of the transaction sets, identification of sender and receiver, and procedures for transmitting and for acknowledging receipt.

Each transaction set is roughly equivalent to a generic “type” of business paper document, such as an Invoice, or a Purchase Order, or a Report of Test Results. A three-digit number, called a standard-development track number, is used to identify each type of electronic document. As an example, a purchase order has a standard-development track number of 850, the invoice is an 810, and a request for quotation is an 840.

Each type of transaction set, in turn, is made up of a series of “segments”—each roughly equivalent to a “line”, “block”, or “field” of related data on a paper form. A segment code name is used to identify a logical and predefined combination of related data elements. For example, a segment code “DTM” specifies that “date-and-time” usually has three related data elements. The first data element would contain a code number or character indicating the kind of date to follow, such as shipping date, invoice date, publication date, or other pre-specified date. The second data element would contain the date itself, using six digits, and the third data element would be the time of day. Special characters separate data elements within the segment and mark the termination of a segment and the beginning of the next segment.

Another example of a segment might be the “PER” segment that represents the name and telephone number of the “person to contact” which is coded in X12 as:

PER*1C*W. M. Smith*TE*6035551234*\

where “PER” is the identifier for the segment, and “1C” and “TE” are the reference codes for person name (W. M. Smith) and phone number (6035551234). “\” signifies end of segment.

The data element dictionary provides definitions for the individual elements of data which are assembled to compose each segment of information within the electronic transaction.

The data element dictionary defines the data elements that can be transmitted and provides a standard identifying code for each element. Data elements are the X12 “atoms”, the basic building blocks of the record being transmitted. Additionally, the X12 dictionary contains tables of predefined code values for commonly encountered items of business data. An example of data elements often found together are the telephone number of a point of contact; the X12 reference code is “TE,” which when encountered tells the receiver that the following data item (e.g. “603-555-1212”) should be interpreted as a telephone number rather than a fax or pager number. The value “TE” is an example of a standard, predefined X12 code value, and the phone number itself is an example of a user-supplied value. The X12 standards provide a powerful combination of predictable positions—or data “pigeonholes”—in which to place or find both kinds of elements of data.

In practice, the originator of an electronic transaction uses the X12 standards to construct a transaction which could be easily interpreted by a recipient familiar with X12, or, more importantly, the recipient's data processing equipment. The originator system utilizes the data element dictionary to identify how each element in his message should be coded, to determine how each of those elements should be sequenced in the order established in the segment dictionary, how those segments should be placed in a segment sequence within a transaction document, and how the transaction set should be grouped within a single transmission.

Despite the ultimate goal of EDI to standardize transactions between businesses, there is no true single standard governing the format of a transaction, as a practical matter. Instead, there are multiple data dictionaries defining transaction formats, with multiple versions which proliferate the business world, both domestically and globally. In addition to the X12 document sets discussed above, other formats include UN/EDIFACT (United Nations rules for Electronic Data Interchange For Administration, Commerce and Transport), CEFACT (Centre for Facilitation of Procedures and Practices for Administration, Commerce and Transport), NACHA (National Automated Clearinghouse Association), and SWIFT (Society for Worldwide Interbank Financial Telecommunications). From year to year, each of these data dictionaries is updated and a new version is issued. The update includes the addition of new “codes”, or entries, to the data dictionary, the deletion of codes, as well as modifications of existing codes. For example, as of the year 1999, at least 13 different versions of X12 were in existence (version 2000 through version 4030). In a typical X12 version, over 63 data segments, 630 fields of information, and 10,000 codes exist for financial EDI. These statistics are compounded with each and every X12 version.

Therefore, from a practical standpoint, only large companies that exert substantial leverage over their trading partners can truly realize the efficiencies of EDI by using a single standard (e.g. their standard) while all of their trading partners conform to their standards.

If a company can not leverage its trading partners to us EDI in their standard, EDI is not likely to provide any cost savings as the multiple number of standards that would need to be maintained would likely cost more than data entry. For example, if a company without adequate leverage to provide for all of its suppliers to use a single EDI standard for sending invoices to the company, the company would have to maintain multiple dictionaries on its system and still be required to maintain a manual data entry department for those suppliers that do not use any form of EDI. Such costs would defeat any cost savings of receiving a portion of the invoices electronically.

What is needed is an invoice receipt and management system that can accept invoices from a plurality of suppliers using a plurality of electronic formats, manage and normalize the invoice data, and to provide the invoices to the customer in an electronic data structure that is compatible with the customers systems for electronic data entry.

### SUMMARY OF THE INVENTION

A first aspect of the present invention is to provide an automated invoice management system for operation with a plurality of vendor client systems and at least one payer client system. The automated invoice management system comprises a network circuit for communicating invoice management data with the plurality of client systems, a database, a session management engine, and a translation engine.

The session management engine comprises means for establishing a secure session with at least a first vendor client system and with at least one payer client system through the network circuit, and means for receiving a first vendor invoice transaction compliant with a first vendor client transaction definition from the first vendor client system that includes a customer identification number.

The translation engine comprises means for identifying a payer client associated with the customer identification number, means for mapping data from at least one field from the first vendor invoice to at least one field of an export invoice that is compliant with a payer client transaction definition, and means for adding a vendor number that is associated with the first vendor client system and is compliant with the payer client transaction definition to at least one field of the export invoice.

The means for adding a vendor number may comprise means for identifying a normalized vendor identification number that is associated with the first vendor client system, means for associating the vendor number to the normalized vendor identification number, and means for replacing the normalized vendor identification number with the vendor number in the export transaction. The session management engine may include means for storing the normalized vendor identification number in the database.

For working with remittance transactions, the session management engine system may further comprise means for receiving a payer remittance transaction compliant with a payer client remittance transaction definition from the payer client system that includes remittance data associated with the export transaction and the vendor number. The translation engine may further comprise means for identifying the vendor client system associated with the vendor number; means for mapping data from at least one field from the payer remittance transaction to at least one field of an export remittance transaction that is compliant with a vendor remittance transaction definition; and means for adding a customer number that is associated with the payer client system and is compliant with the vendor remittance transaction definition to at least one field of the export remittance transaction.

A second aspect of the present invention is to provide a method for providing automated invoice management services to a plurality of vendor client systems and at least one payer client system. The method comprises: a) establishing a secure session with at least a first vendor client system and with at least one payer client system through a network circuit; b) receiving a first vendor invoice transaction compliant with a first vendor client transaction definition from the first vendor client system that includes a customer identification number; c) identifying a payer client associated with the customer identification number; d) mapping data from at least one field from the first vendor invoice to at least one field of an export invoice that is compliant with a payer client transaction definition; and e) adding a vendor number that is associated with the first vendor and is compliant with the payer client transaction definition to at least one field of the export invoice.

The step of adding a vendor number may comprise: i) identifying a normalized vendor identification number that is associated with the first vendor client system; ii) associating the vendor number to the normalized vendor identification number; and iii) replacing the normalized vendor identification number with the vendor number in the export transaction.

The method may further include: associating an element in the normalized transaction to at least a portion of an element in the first vendor client transaction definition and at least a portion of an element in the payer client transaction definition; and associating the normalized vendor identification number in the normalized transaction to the first vendor client system and to the vendor number.

For working with remittance transactions, the method may further comprise: a) receiving a payer remittance transaction compliant with a payer client remittance transaction definition from the payer client system that includes remittance data associated with the export transaction and the vendor number; b) identifying the vendor client system associated with the vendor number; c) mapping data from at least one field from the payer remittance transaction to at least one field of an export remittance transaction that is compliant with a vendor remittance transaction definition; and d) adding a customer number that is associated with the payer client system and is compliant with the vendor remittance transaction definition to at least one field of the export remittance transaction.

For a better understanding of the present invention, together with other and further aspects thereof, reference is made to the following description, taken in conjunction with the accompanying drawings, and its scope will be pointed out in the appended clams.

### BRIEF DESCRIPTION OF THE DRAWINGS

FIG. 1 is a block diagram of an automated invoice and remittance transaction management architecture in accordance with one embodiment of the present invention;

FIG. 2 is a block diagram of an automated invoice and remittance transaction management system in accordance with one embodiments of the present invention;

FIG. 3a is a table diagram representing column names in an exemplary invoice and remittance database table in accordance with one embodiment of the present invention;

FIG. 3b is a table diagram representing column names in an exemplary invoice and remittance database table in accordance with one embodiment of the present invention;

FIG. 3c is a table diagram representing column names in an exemplary invoice and remittance database table in accordance with one embodiment of the present invention;

FIG. 3d is a table diagram representing column names in an exemplary invoice and remittance database table in accordance with one embodiment of the present invention;

FIG. 3e is a table diagram representing column names in an exemplary invoice and remittance database table in accordance with one embodiment of the present invention;

FIG. 4a is a table diagram representing column names in an exemplary value set database table in accordance with one embodiment of the present invention;

FIG. 4b is a table diagram representing column names in an exemplary values set database table in accordance with one embodiment of the present invention;

FIG. 5 is a flow chart representing an exemplary work flow script in accordance with one embodiment of the present invention;

FIG. 6a is a flow chart representing an exemplary work flow script in accordance with one embodiment of the present invention;

FIG. 6b is a flow chart representing an exemplary work flow script in accordance with one embodiment of the present invention;

FIG. 7a is a table diagram representing invoice and remittance transaction management menu choices in accordance with one embodiment of the present invention;

FIG. 7b is a flow chart representing an exemplary work flow script in accordance with one embodiment of the present invention;

FIG. 7c is a flow chart representing an exemplary work flow script in accordance with one embodiment of the present invention;

FIG. 7d is a flow chart representing an exemplary work flow script in accordance with one embodiment of the present invention;

FIG. 7e is a flow chart representing an exemplary work flow script in accordance with one embodiment of the present invention;

FIG. 8a is a flow chart representing exemplary translation processing of an import transaction in accordance with one embodiment of the present invention;

FIG. 8b is a flow chart representing an exemplary translation of an export transaction in accordance with one embodiment of the present invention;

FIG. 9a represents an exemplary client transaction definition in accordance with one embodiment of the present invention;

FIG. 9b represents an exemplary client transaction definition in accordance with one embodiment of the present invention;

FIG. 10a is a table representing exemplary element mapping of an inbound transaction in accordance with one embodiment of the present invention; and

FIG. 10b is a table representing exemplary element mapping of an outbound transaction in accordance with one embodiment of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

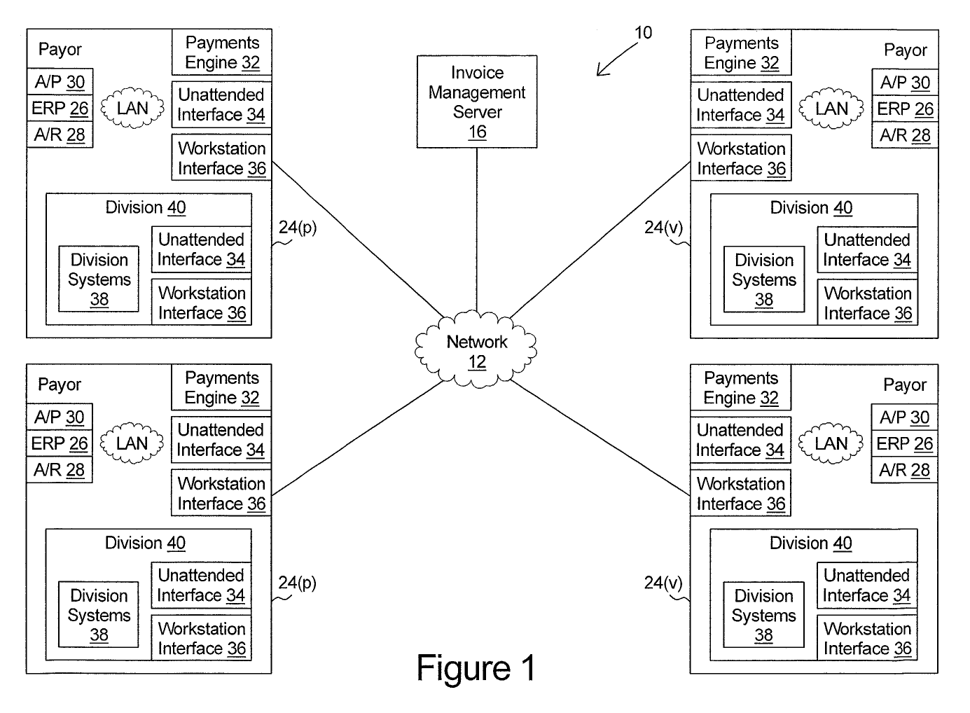

FIG. 1 illustrates exemplary architecture of an automated invoice receipt and management system 10 in accordance with one embodiment of the present invention. The architecture 10 comprises an automated invoice receipt and invoice and remittance management server 16 that is coupled to a community of client systems 24 by a network 12.

The client systems 24 comprise a plurality of payer client systems 24p and a plurality of vendor client systems 24v. Each client system 24 may include a proprietary database system 26 that may include an accounts payable system 30, an accounts receivables system 28, and other financial resource planning systems for recording and managing the client's invoice transactions with other clients 24. Each database system 26 may use different transaction definitions for electronically entering and extracting data (either through manual data entry screens or batch input/output files) and, each data base system 26 may use different value sets within elements of each transaction definition. For example, the database system 26 of one vendor 24v may identify a particular customer client 24p by a customer number “C-001” while another database system 26 of another vendor 24v may identify the same customer client 24p by a customer number “CXN57A”.

Additionally, each client system 24 may have one or more division systems 40 that include a division resource management database 38 that utilizes different transaction definitions and different value sets than the client database system 26.

Each client system 24 and each of its division systems 40 may interface with the invoice management server 16 using at least one of a work station 28 and a unattended interface module 30 that will establish a secure session with the invoice management server 16 for the exchange of invoice transactions and remittance transactions.

The invoice management server 16 seamlessly manages the electronic exchange of invoice transactions and remittance transactions data amongst the client systems 24 (and the division systems 40) by independently communicating invoice data with each such client system 24 (or division system 40) using transaction definitions and value sets that are compatible with such client's (or division's) database system 26 or 38 respectively.

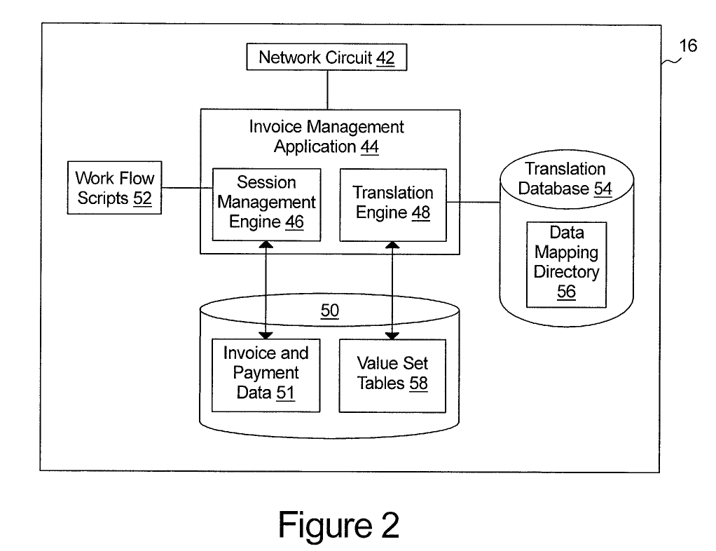

Turning to FIG. 2, exemplary structure of the server 16 is shown. The server 16 includes an invoice management application 44 that is coupled to a network circuit 42 and a database 50.

The network circuit 42 includes circuitry for interfacing between the invoice management application 44 and a network service providers communication medium for providing access to the network 12. In the exemplary embodiment, the circuitry may include appropriate routers, firewalls, and perimeter networks to provide for a secure interface and to prevent unauthorized access to the invoice management application 44 by other computing devices coupled to the network 12.

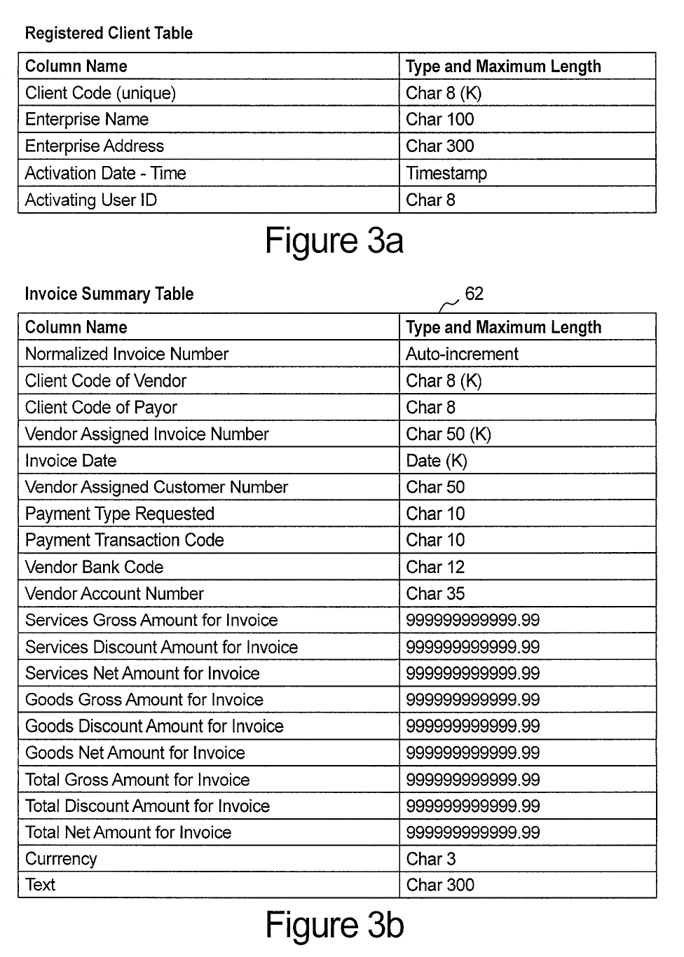

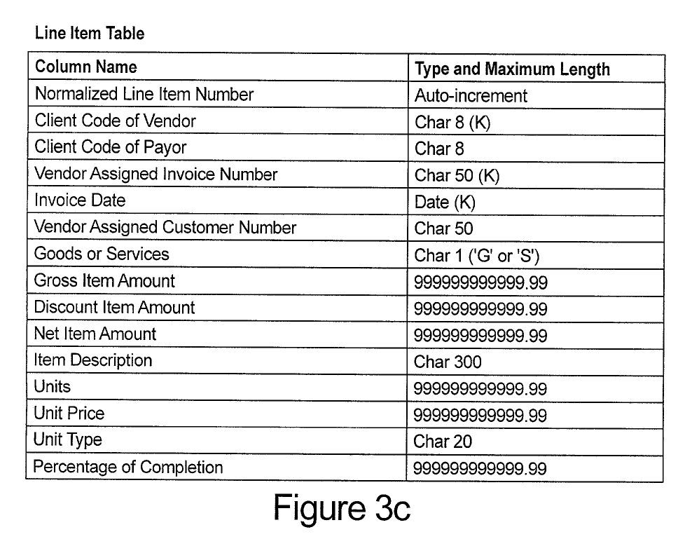

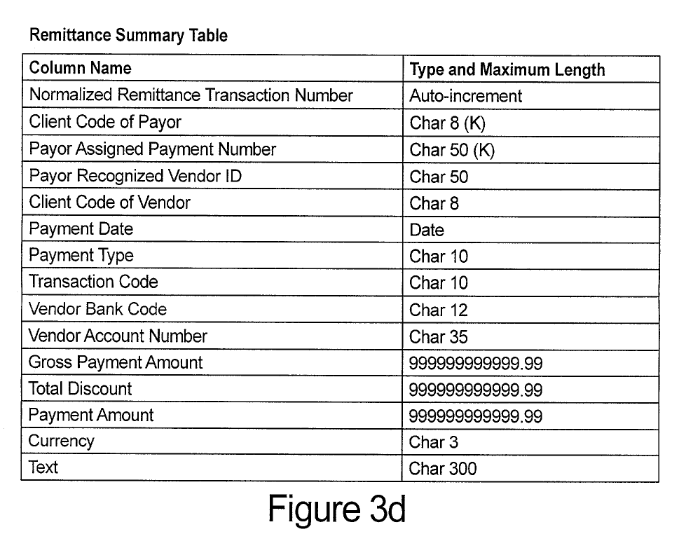

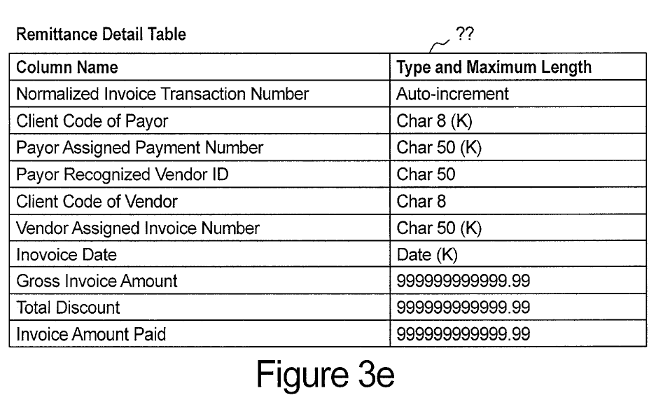

The database 50 may be a relational database and store invoice and payment data 51 in a table structure. Turning to FIGS. 3a-3e, exemplary table structures are shown. The registered client table of FIG. 3a associates a client's identification information such as the client's enterprise name and address with a unique normalized client code.

The invoice summary table of FIG. 3b, associates a unique normalized invoice transaction number to each invoice transaction managed by the invoice transaction server 16. Associated with the unique normalized invoice transaction number are a plurality of fields comprising the normalized client code of the vendor, the normalized client code of the payer, a vendor assigned invoice number, a vendor assigned customer number for the payer, and an invoice date.

Because the quantity of line items on an invoice is variable, line item information is stored in a line item table as represented by FIG. 3c. The line item table associates line item detail for each line item on an invoice to the particular invoice using the vendor assigned invoice number, the invoice date, and the normalized client code of the vendor, and the vendor assigned customer number of the payer.

The remittance summary table of FIG. 3d associates a unique normalized remittance transaction number to each remittance transaction managed by the invoice transaction server 16. Associated with the unique normalized remittance transaction number are a plurality of fields including the normalized client code of the payer, the normalized client code of the vendor, and a payer assigned payment number.

Because each remittance may apply to one or more vendor invoices (in whole or in part), each remittance payment can be considered to have a variable number of line items. As such, remittance line item information that includes identification of the paid invoices is stored in the remittance detail table represented by FIG. 3e.

The remittance detail table of FIG. 3e associates remittance detail such as the vendor assigned invoice number and the amount of the invoice paid to the payer assigned payment number and payment date.

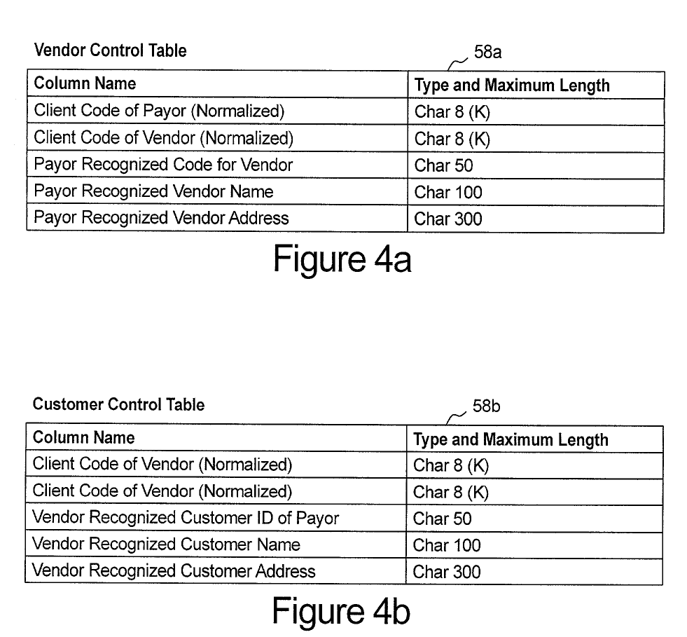

Returning to FIG. 2, because each client may recognized other clients by customer numbers and vendor numbers that comprise different value sets than the normalized client ID numbers, the value set tables 58 associate value sets of each client transaction definition to normalized value sets. Turning to FIGS. 4a and 4b in conjunction with FIG. 2, the vendor control table 58a associates a payer recognized vendor ID code, vendor name, and vendor address to each vendor within the community that transact business with the payer. It should be appreciated that a single vendor identified by a normalized client ID number may be recognized to a payer as multiple vendors (such as different divisions or locations), each assigned a different payer recognized vendor ID code, vendor name, and vendor address. The vendor control table 58a accommodates such variations.

Similarly, the customer control table 58b, associates a vendor recognized customer ID code, customer name, and customer address to each payer client within the community that transacts business with the vendor client. Again it should be appreciated that a single payer identified by a normalized client ID number may be recognized to a vendor as multiple customers, each assigned a different vendor recognized customer ID code, customer name, and customer address. The customer control table 58b accommodates such variations.

Returning to FIG. 2, the invoice management application 44 includes applicable circuits for establishing and managing a secure session with each unattended interface 34 and each workstation 36 via the network circuit 42.

The invoice management application 44 further includes a session management engine 46 that controls the interface of invoice and remittance transaction files between the server 16 and the unattended interface module 30 or workstation 28 during the secure session in accordance with workflow scripts 52.

The invoice management application 44 further includes a translation engine 48 for interfacing invoice and remittance transactions between the invoice and remittance tables 51 of database 50 and each interface module 34 and workstation 36 using transaction definitions and value sets that are compatible with the client database system 26 (or division database system 38) for which such unattended interface module 34 or workstation 36 is operating.

Session Management Engine

The session management engine 46 operates a menu driven application for each of the unattended interface modules 34 and work stations 36 that have open communication sessions to the invoice management application 44.

During operation the session management engine 46 receives client instructions to perform various predetermined invoice and remittance transaction management operations and then performs processing steps in response thereto in accordance with work flow scripts 51.

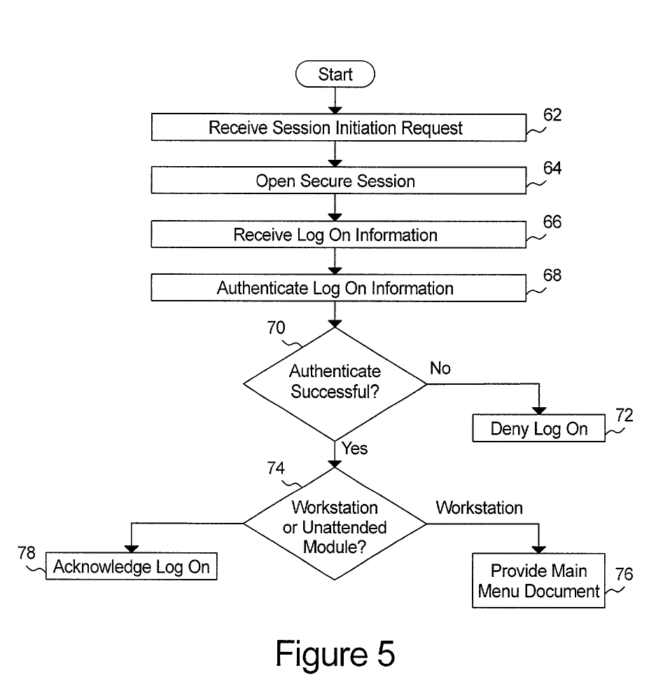

Turning to the flowchart of FIG. 5 in conjunction with FIG. 2, exemplary steps performed by the session management engine 46 to logon each unattended interface module 34 or workstation 36 and to initiate invoice management following logon are shown.

Step 62 represents receipt of a session initiation request from the client (e.g. the workstation 36 or the unattended interface module 34). Step 64 represents opening a secure session with the client and step 66 represents receiving logon information from the client that may include a client ID number and password. At step 68 the logon information is authenticated by comparing it to a password database and, at step 70, if the logon information does not authenticate, access is denied at step 72.

In the exemplary embodiment, the password table will also include an identifier as to whether the client is a workstation 36 or an unattended interface module 34. As such, if the logon information does authenticate at step 70, then at step 74 the session management engine 46 may determine that the client is a workstation 36 and proceed to step 76 wherein a main menu document is provided to the workstation 36 or determine that the client is an unattended interface module 34 and proceed to step 78 wherein the logon is acknowledged to the unattended interface module 34.

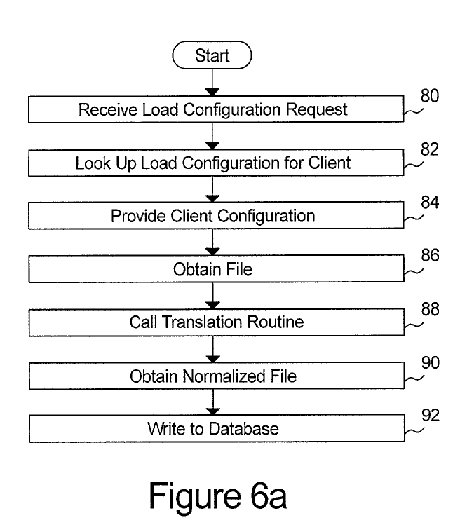

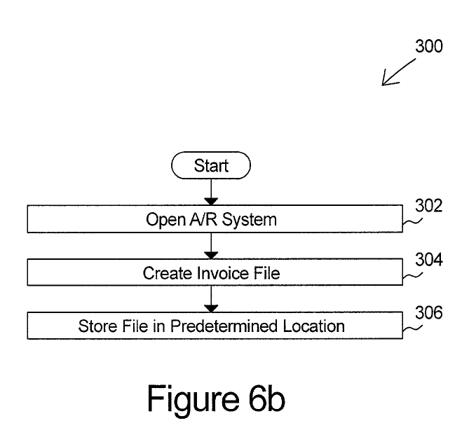

After the unattended interface module 34 completes logon, the flow chart of FIG. 6 represents exemplary steps performed by the session management engine 46 for interacting with the unattended interface module 34. Referring to FIG. 6bin conjunction with FIG. 2, Step 80 represents receiving a request for a file loading configuration from the unattended interface module 34 and step 82 represents providing the file loading configuration data to the unattended interface module 34. Such configuration data may include a location on the client network to find a file for loading.

Step 86 represents obtaining the file. In the exemplary embodiment, the unattended interface module 34 will send the file through the secure session and write the file to a predetermined location. The session management engine 46 will then retrieve the file from such location.

Step 88 represents calling the translation routine of the translation engine 48 (discussed later herein) to convert the file from the client transaction definition and value set to the normalized transaction definition and value set.

Step 90 represents receiving the normalized transaction definition file from the translation engine 48 and step 92 represents loading the normalized transactions into the invoice and payment records 51 in the database 50.

On the vendor side of the transaction, the invoice data is generated by the vendor's A/R system 28. As is understood in the art, A/R systems can be adapted to output a data file representing invoice data in a variety of formats. FIG. 6bis flowchart 300 of an exemplary process for outputting data. In step 302, the A/R system 28 is opened in accordance with the particular A/R system used. In step 304, the invoice data is created. In this step, the invoice data can be created in a custom and/or proprietary and/or off-the-shelf fashion, as is known in the art. In step 306, the invoice data file is stored in a predetermined location. The location may be, for example, a local folder, as alluded to above with reference to FIG. 6a. Preferably, the location is determined by the unattended interface module 34 to permit automatic transfer of invoice files to the invoice management server 16 as described with reference to FIG. 6a.

In an exemplary embodiment, the unattended interface module 34 comprises an executable file that logs on to the invoice management server at user-defined and/or periodic intervals to transfer invoice data thereto. Once transferred, the invoice file can be translated in a manner described herein to comport with the customer's A/P system.

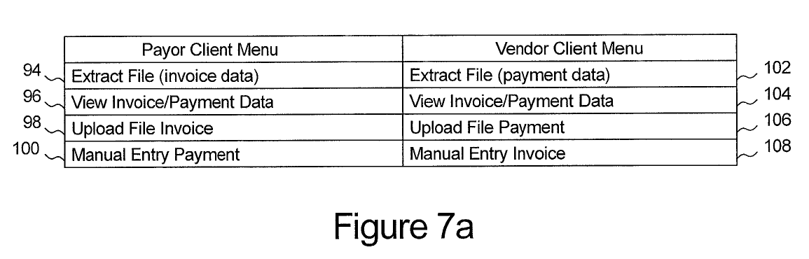

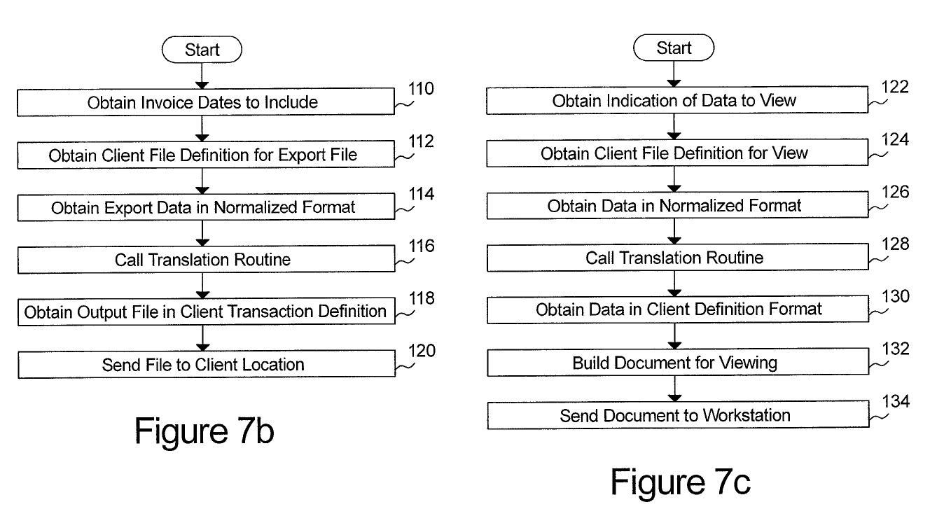

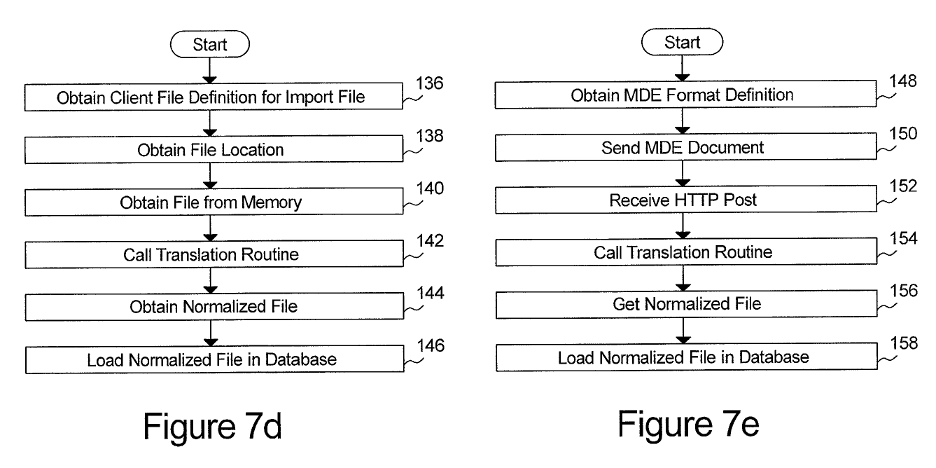

After logon of a workstation 36 is complete the main menu document provided to the workstation 36 at step 76 of FIG. 5 may include menu choices for managing invoice and remittance transactions as a payer client or as a vendor client with exemplary menu choices for each represented by the table of FIG. 7. When managing invoice and remittance transactions as a payer, exemplary management operation may include extracting a file of incremental invoice transactions from the database 94, viewing invoice and/or payment data 96, uploading a file of payment transactions 98, and manual data entry of a payment 100.

When managing invoice and remittance transactions as a vendor, exemplary management operations may include extracting a file of incremental payment transactions from the data base 102, viewing invoice and/or payment data 104, uploading a file of invoice transactions 106, and manual data entry of an invoice 108.

Turning to the flowchart of FIG. 7b in conjunction with FIG. 2, exemplary steps for extracting a file of incremental invoice or remittance transactions (94 and 102 of FIG. 7a) are shown. Step 110 represents obtaining and indication of the incremental transactions to include in the extracted file. In the exemplary embodiment, the session management engine 46 provides a document to the workstation 36 to prompt the user of the workstation 36 to enter a start date and an end date such that the incremental transactions are those that fall between such dates. It should be appreciated that the extracted file may cover a time period in which, in the case of invoice transactions, will include invoice transactions from multiple vendors for the payer and in the case of remittance transactions may include multiple remittance transactions from multiple customers of the vendor.

Step 112 represents obtaining the client file definition for the export file. The session management engine 46 may obtain this by either looking up a transaction definition associated with the particular client 24 in an applicable database file or by providing a document to the workstation 36 to prompt the user of the workstation 36 to select from available client transaction definitions.

Step 114 represents obtaining the incremental transactions from the database 50 in the normalized format. Step 116 represents calling the translation routine of the translation engine 48 and step 118 represents receiving the transactions from the translation engine 48 that are compatible with the client transaction definition and with client value sets. Step 120 represents building a file of the incremental transactions and sending the file to the workstation 36 through the secure session.

The flowchart of FIG. 7c represents exemplary steps associated with viewing invoice/payment transactions (96 and 104 of FIG. 7a).

Step 122 represents obtaining an indication of the transactions that the user of the workstation 36 desires to view. This may include providing the workstation 36 with documents representing menus of choices for user selection and obtaining a post of the user selection through the secure session.

Step 124 represents obtaining the client transaction definition for the transactions to be viewed either through operator selection of available definitions or by looking up a client transaction definition that is associated with the client 24 in an applicable database file.

Step 126 represents obtaining normalized transaction data from the database that corresponds with the indication obtained at step 122. Step 128 represents calling the translation routine of the translation engine 48 and step 130 represents obtaining the transaction compatible with the client transaction definition and with client value sets from the transaction engine 48. Step 132 represents building a document to display the transactions and step 134 represents sending the document to the workstation 36 through the secure session.

The flowchart of FIG. 7d represents exemplary steps performed by the session management engine 46 in response to user selection of uploading a file (98 or 106 of FIG. 7a).

Step 136 represents obtaining the client transaction definition for the file to be imported either through operator selection of available definitions or by looking up a client transaction definition that is associated with the client 24 in an applicable database file. Step 138 represents obtaining the file location from the workstation 36 and step 140 represents providing the workstation 36 with applicable scripts to upload the file from the location through the secure session and write the file to a predetermined location.

Step 140 represents obtaining the file from the predetermined location and step 142 represents calling the translation routine of the translation engine 48. Step 144 represents obtaining the normalized transactions from the translation engine 48 and step 146 represents loading the transaction into the invoice and payment records 51 of the database 50.

The flowchart of FIG. 7e represents exemplary steps performed by the session management engine 46 to provide manual entry of invoice or payment data (100 and 108 of FIG. 7a).

Step 148 represents obtaining the client transaction definition for the file to be imported either through operator selection of available definitions or by looking up a client transaction definition that is associated with the client 24 in an applicable database file.

Step 150 represents sending a manual data entry document compliant with the client transaction definition to the workstation 36. Step 152 represents receiving a post of the manually entered transaction back from the workstation 36 over the secure session.

Step 154 represents calling the translation routine of the translation engine 48 and step 156 represents receiving the normalized transaction back from the translation engine 48. Step 158 represents loading the normalized transaction into the invoice and payment records 51 of the database 50.

Translation Engine

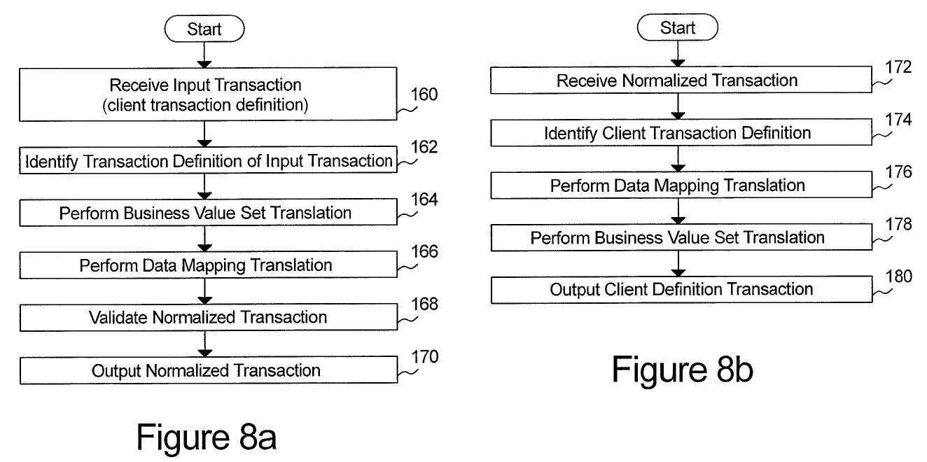

Turning to FIGS. 8a and 8b in conjunction with FIG. 2, exemplary operation of the translation engine 48 is shown. The translation engine 48 translates invoice transactions between a client transaction definition and value set compatible with a clients database system 26 (or a division's database system 38) and a normalized transaction definition and value set compatible with the invoice and payment records 51 in the database 50. Referring to FIG. 8a, operation of the translation engine 48 with respect to translating a transaction from a client definition transaction to a normalized transaction is shown.

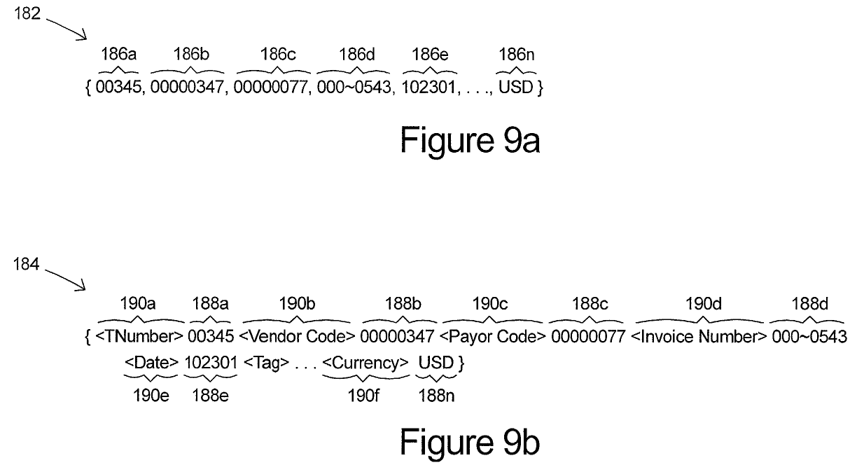

Step 160 represents receipt of a transaction corresponding to the client transaction definition. Referring briefly to FIGS. 9a and 9b, portions of exemplary client transactions are represented. Exemplary transaction 182 is a comma delimitated transaction definition that includes a plurality of data elements 186a-186n each of which is separated from adjacent data elements 186a-186n by a comma symbol. Each data element 186a-186n is identified by its sequential location within the transaction (e.g. data element 186e which is the 5^{th} data element in the transaction represents invoice date) and includes data that corresponds with transaction format rules. For example, the transaction format rules that correspond to the invoice date may require that the date element 186e contain 6 digits in a MMDDYY format.

Exemplary transaction 184 is a tagged data element transaction definition that includes a plurality of data elements 190a-190n each of which is positioned following an element tag 192a-192n that identifies the contents of the following data element 190a-190n. Again, the data within each element complies with transaction format rules.

It should be appreciated that the exemplary transactions 182 and 184 each represent only a portion of a transaction. An actual transaction may consist of many more elements and the permutations of client transaction definitions may be large.

Step 162 represents identifying the particular client transaction definition with which the received transaction complies. In the exemplary embodiment, the session management engine 46 will provide a transaction definition type indicator to the translation engine when it calls the translation routine. The transaction definition type indicator will correspond to the type of transaction that the client system indicated. However, it is envisioned that the translation engine 48 may independently determine the client transaction definition type.

Step 164 represents performing business value set translation. Because each client database system 26 (and each division database system 38) may identify other clients, products, services, and other invoice information by different value sets, the value sets must be normalized. For example, a particular client 24 may be identified by a unique client number, client 007 for example, in the normalized transaction. However, the clients database system 26 requires a vendor number and the vendor number that corresponds to client 007 may be V319 for example. As such, the translation engine 48 relies on client specific business value translation tables 58 to map business values from client specific values 192 in the client transaction to normalized values 194.

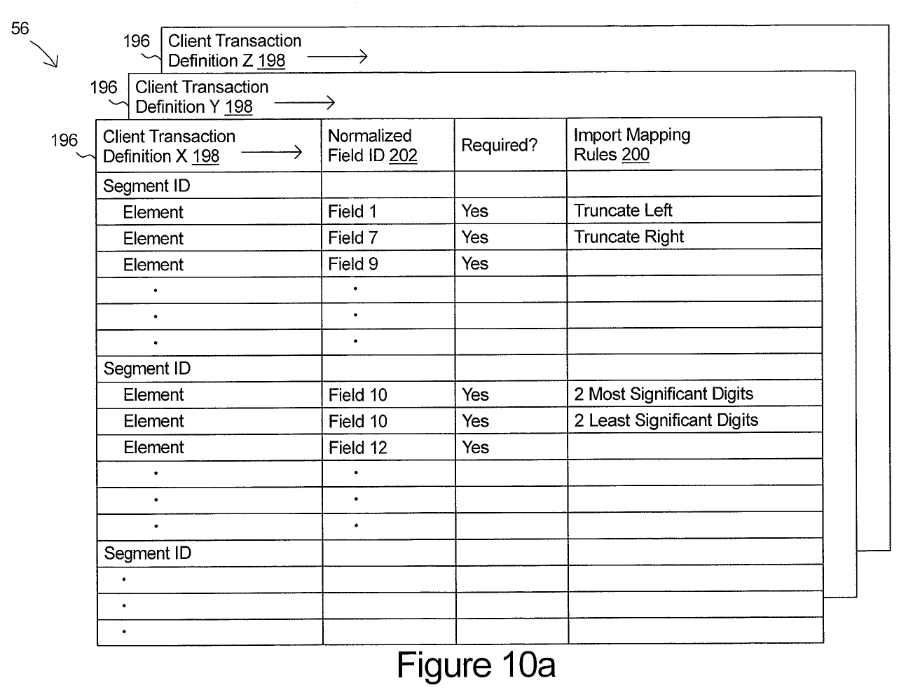

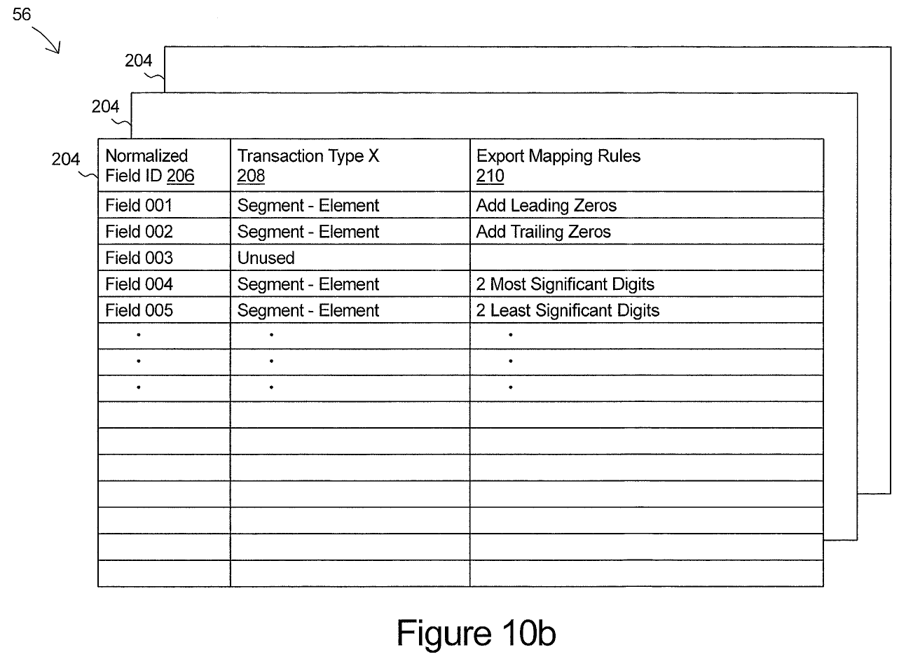

Step 166 represents performing data mapping translation. Referring briefly to FIG. 10a, to perform data mapping translation, the translation engine relies on a data mapping table 196 for each of the possible client transaction definitions that are stored in the data mapping database 56. Each data mapping table 196 associates a client transaction field 198 and mapping rules 200 to each field 202 in the normalized transaction. The table 136 also indicates whether the field is required for purposes of validation discussed later herein. Because each field in a normalized transaction may include data that is only a portion of a filed from a client transaction (for example, a client transaction date field may include a month, day, and year organized as MMDDYYYY while the normalized transaction may include three separate fields identified as month, day, and year), the mapping rules 200 may indicate which portion of the client transaction field to map to the normalized transaction field. Because the normalized transaction field may be either longer or shorter than the client transaction filed, the mapping rules 200 may indication which characters to truncate or which characters to add as default characters.

After performing both business value translation and data mapping translation, the normalized data must be validated at step 168. The translation engine 48 validates the normalized transaction by assuring that each field identified as required in the mapping table 196 is included and that the data within each such required field matches field requirements.

Step 170 represents outputting the normalized transaction to the session management engine 46.

Turning to FIG. 8b, exemplary steps for translating a normalized transaction to a transaction compliant with a client transaction definition are shown. Step 172 represents receiving the normalized transaction and step 174 represents identifying the client transaction definition required. In the exemplary embodiment, the client transaction definition will be provided as a client transaction indicator by the session management engine 46.

Step 176 represents performing data mapping translation. Referring briefly to FIG. 10, to perform data mapping translation, the translation engine 48 relies on mapping tables 204 that are stored in the data mapping database 56. The mapping tables 204 associate each normalized data field 206 to a client transaction definition data field 208 (if required) and to mapping rules 210.

Because the client transaction definition data field 208 may require data from one or more normalized fields 206 (e.g. the date field example discussed earlier), the mapping rules may identify that the normalized field 206 is mapped to a specific sub portion of the client transaction definition field 208. Because the client transaction data field 208 may have more or fewer characters, the mapping rules may indicate which characters to truncate and/or default characters to add.

Step 178 represents performing business value translation. As discussed with respect to step 164, business value translation is performed utilizing business value translation tables 58.

Step 180 represents outputting the transaction that complies with the client transaction definition to the session management engine 46.

It should be appreciated that the systems and methods of the present invention provide for the communication and control of multi-media messages by a central control unit and a plurality of space station communication devices operating under the control of the control unit. This coordinated and integrated system architecture enables the space station communication device to merge the functionality and internal data of various portable subscriber devices into the space station communication device, to direct the functionality and data of the space station communication device to a selected one of the portable subscriber devices, and to provide the subscriber with a simple subscriber interface.

Although the invention has been shown and described with respect to certain preferred embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of the modular multi-media communication management system of the present invention. The present invention includes all such equivalents and modifications, and is limited only by the scope of the following claims.

What is claimed is:

1. A method for automatically uploading invoice files to an invoice management server for operation with a vendor client system and a payer client system, the method comprising the steps of:
generating an invoice data file;
storing said invoice data file in a predetermined location on a vendor client system;
retrieving said invoice data file from said predetermined location; and
automatically transmitting said invoice data file to an invoice management server, said invoice management server being accessed by one or more said payer client system.

2. A method as claimed in claim 1, further comprising the steps of:
opening an accounts receivable system; and
creating said invoice data file.

3. A method as claimed in claim 1, further comprising the step of translating said invoice file to a format compatible with said payer client.

4. A method as claimed in claim 1, further comprising the step of transmitting said invoice data file from said invoice management server to said payer client system.

5. A method as claimed in claim 1, further comprising the step of establishing a secure session with said vendor client system and with said payer client system through a network circuit.

6. A method as claimed in claim 1, further comprising the steps of:
identifying a payer client associated with the customer identification number contained within said invoice data;
mapping data from at least one field from the vendor invoice to at least one field of an export invoice that is compliant with a payer client transaction definition; and
adding a vendor number that is associated with the first vendor client system and is compliant with the payer client transaction definition to at least one field of the export invoice.

8. A method as claimed in claim 7, further comprising the steps of
identifying a normalized vendor identification number that is associated with the first vendor client system;
associating the vendor number to the normalized vendor identification number; and
replacing the normalized vendor identification number with the vendor number in the export transaction.

9. A system for automatically loading an invoice from a vendor client system to an invoice management system, comprising:
a directory associated with said vendor client system for storing an invoice data file in a predetermined location within said directory; and
an unattended interface module adapted to automatically search said directory for said invoice data file and automatically upload said invoice data file to said invoice management system.

10. A system as claimed in claim 9, said vendor client system further comprising an A/R system adapted to generate said invoice data file.

11. A system as claimed in claim 9, further comprising a network interface for establishing a network connection between said vendor client system and said invoice management system.

12. A system as claimed in claim 9, said invoice management system further comprising:
a translation engine comprising:
means for identifying a payer client associated with a customer identification number located within said invoice data;
means for mapping data from at least one field from the first vendor invoice to at least one field of an export invoice that is compliant with a payer client transaction definition; and
means for substituting a business value from at least one field in the first vendor invoice transaction to a business value compliant with the payer client transaction definition in the export invoice.
